(19) United States
(12) Patent Application Publication
(10) Pub. No.: US 2001/0004678 A1
(43) Pub. Date: Jun. 21, 2001

(54) Vibration massage device

(76) Inventors: Robert D. Leventhal, Los Angeles, CA (US); Paul B. Thomas, San Pedro, CA (US)

Correspondence Address: ROZSA & CHEN, 15910 VENTURA BOULEVARD, SUITE 1601, ENCINO, CA, 91436

(21) Appl. No.: 09/754,928

(22) Filed: Jan. 8, 2001

Related U.S. Application Data
(63) Continuation-in-part of application No. 09/467,562, filed on Dec. 20, 1999.

(51) Int. Cl. A61H 1/00

(52) U.S. Cl. 601/46

(57) ABSTRACT

A vibration massage device is used for generating vibrations to a transmitting plate which in turn generates vibrations to a plurality of protruding fingertips and the body part positioned on the fingertips for providing an improved massaging effect on the body part. The vibration massage device is further used in conjunction with a fluid filled bladder, where the fluid filled bladder is positioned on top or underneath the transmitting plate for creating increased pressure from the protruding fingertips against the user.

This application is a continuation-in-part of application Ser. No. 09/467,562 filed on Dec. 20, 1999, now pending.

### BACKGROUND OF THE INVENTION

1. Field of the Invention

The present invention generally relates to the field of massage devices. More particularly, the present invention relates to the field of massage devices having vibration generators or means for generating harmonic vibrations. In particular, the present invention relates to the field of massage devices having at least one vibration generator and at one air bladder.

2. Description of the Prior Art

Specifically, massage devices are well known in the art. However, these prior art massage devices do not provide adequate massaging effect to a body part of a user to make them effective.

It is desirable to provide a harmonic vibration massage device with the capability of increasing or decreasing the amplitude of the harmonic vibrations generated by two or more vibration generators mounted to a transmitting plate. It is also desirable to provide a harmonic vibration massage device or the like that not only supports a weight of an individual who sits or rests on the harmonic vibration massage device but also provides in a much more efficient way a harmonic massaging effect on the body part of the individual positioned on the device.

It is further desirable to provide a vibration massage device with the capability of providing a massaging effect on the body part utilizing at least one vibration generator, an air bladder and a plurality of fingertips or nodes.

### SUMMARY OF THE INVENTION

The present invention is a harmonic vibration massage device for generating at least two wave forms at two distinct areas of a transmitting plate, where the wave forms are converging on each other to create a destructive harmony (lower amplitude), a constructive harmony (larger amplitude) or both (lower and larger amplitudes).

It has been discovered, according to the present invention, that by providing a harmonic vibration massage device with at least two or more vibration generators for generating two distinct vibrations at two distinct areas on a transmitting plate, the at least two vibration generators provide the two distinct vibrations which are coupled together to produce harmonic vibrations for providing a harmonic massage effect to a body part of a user.

It is an object of the present invention to provide a harmonic vibration massage device having at least two or more vibration generators or means, each for producing a different harmonic vibration at a different area of a transmitting plate.

It is also an object of the present invention to provide a harmonic vibration massage device having at least two or more vibration generators or means, wherein the wave forms generated by the vibration generators are in destructive harmony which has lower amplitudes.

It is an additional object of the present invention to provide a harmonic vibration massage device having at least two or more vibration generators or means, wherein the wave forms generated by the vibration generators are in constructive harmony which has larger amplitudes.

It is a further object of the present invention to provide a harmonic vibration massage device having at least two or more vibration generators or means, wherein the wave forms generated by the vibration generators are in destructive and constructive harmonies which include lower and larger amplitudes.

It is still a further object of the present invention to provide a harmonic vibration massage device having at least two or more vibration generators or means for generating harmonic vibrations at two distinct areas such that the harmonic vibrations are transmitted to and through transmitting means which in turn creates resonance vibrations to the massage device and the body part which is positioned on the massage device.

Described generally, the present invention is a harmonic vibration massage device having at least two or more vibration generators or means for generating harmonic vibrations to and through transmitting means which in turn creates resonance vibrations to the massage device and the body part positioned on the massage device. The transmitting means has a plurality of protruding fingertips or the like to improve the harmonic massaging effect on the body part of a user positioned against the protruding fingertips.

Described alternatively, the present invention is a harmonic vibration massage device having at least two or more vibration generators or means for generating harmonic vibrations to and through transmitting means which in turn creates resonance vibrations to the massage device and the body part positioned on the massage device. The transmitting means has an upper side with a plurality of protruding finger tips to improve the massaging effect on the body part of a user positioned against the protruding finger tips. The massage device is used in conjunction with a fluid filled bladder, where the fluid filled bladder is positioned underneath the massage device for creating increased pressure against the user.

Described further alternatively, the present invention is a harmonic vibration massage device having at least two or more vibration generators or means for generating harmonic vibrations to and through transmitting means which in turn creates resonance vibrations to the massage device and the body part positioned on the massage device. The massage device is used in conjunction with a fluid filled bladder with an irregular surface, where the fluid filled bladder is positioned on top of the transmitting means and the irregular surface conforms to the body part of a user.

Alternatively, the present invention is a vibration massage device having at least one vibration generator or means for generating vibrations to and through a transmitting plate which in turn generates vibrations to a plurality of protruding fingertips and the body part of a user positioned on the fingertips for providing an improved massaging effect on the body part. The vibration massage device is further used in conjunction with a fluid filled bladder, where the fluid filled bladder is positioned behind the at least one vibration generator for creating increased pressure from the protruding fingertips against the body part of the user.

Still alternatively, the present invention is a vibration massage device having at least one vibration generator or means for generating vibrations to and through a transmitting plate which in turn generates vibrations to a fluid filled bladder and the body part of a user positioned on the bladder for providing an improved massaging effect on the body part. The fluid filled bladder has an irregular surface which conforms to the body part of the user.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is an illustrative diagram showing two vibration generators mounted at two separate locations on a transmitting plate upon a single plane;

FIG. 2 is an illustrative diagram showing two wave forms generated at two distinct areas prior to convergence;

FIG. 3 is an illustrative diagram showing two wave forms generated at two distinct areas at an initial vibration convergence;

FIG. 4 is an illustrative diagram showing two wave forms in a destructive harmony, creating a lower amplitude of the harmony;

FIG. 5 is an illustrative diagram showing two wave forms in unison in a constructive harmony, creating a larger amplitude in the harmony;

FIG. 6 is an illustrative diagram showing the harmonic of two wave forms, rising (constructive) and falling (destructive);

FIG. 7 is an illustrative diagram showing a preferred embodiment of the present invention harmonic vibration massage device;

FIG. 8 is an illustrative diagram showing an alternative embodiment of the present invention harmonic vibration massage device used in conjunction with a fluid filled bladder for creating increased pressure against a user;

FIG. 9 is an illustrative diagram showing one arrangement of the present invention harmonic vibration massage device incorporated within a cushioning apparatus;

FIG. 10 is a cross-sectional view taken along line 10-10 of FIG. 9;

FIG. 11 is an illustrative diagram showing the present invention harmonic plate vibration massage device used on the user's feet;

FIG. 12 is an illustrative diagram showing another embodiment of the present invention harmonic plate vibration massage device incorporated into a foot massage apparatus, where a fluid filled bladder has an irregular surface;

FIG. 13 is a perspective view of a cushioning apparatus with the present invention vibration massage device embedded within the apparatus;

FIG. 14 is a cross-sectional view taken along line 14-14 of FIG. 13; and

FIG. 15 is an illustrative diagram showing a further alternative embodiment of the present invention vibration massage device incorporated into a foot massage apparatus, where a fluid filled bladder has an irregular surface positioned on top of the vibration massage device.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

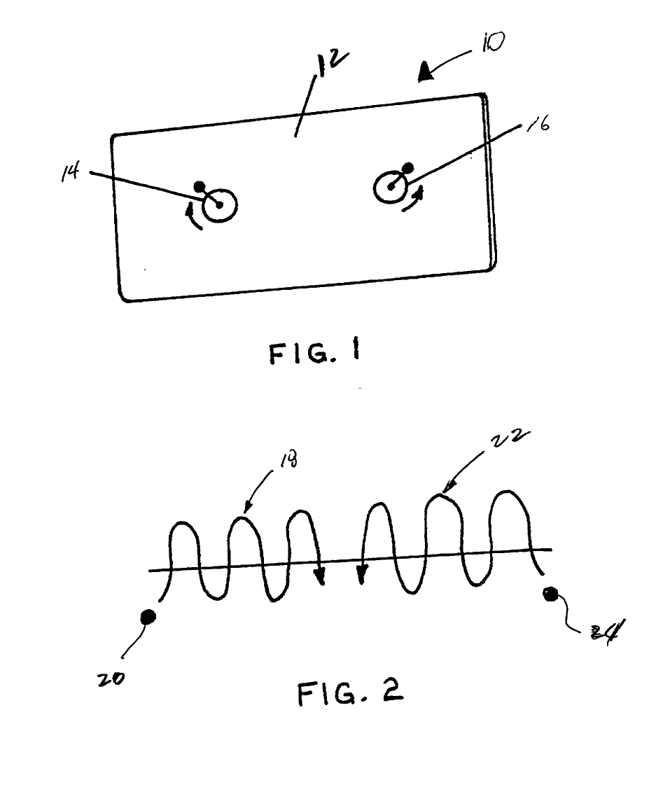

Referring to FIG. 1, there is illustratively shown a preferred embodiment of the present invention harmonic vibration massage device 10 which includes a rectangular shaped transmitting plate 12 and at least two vibration generators 14 and 16 at two distinct areas of the transmitting plate 12.

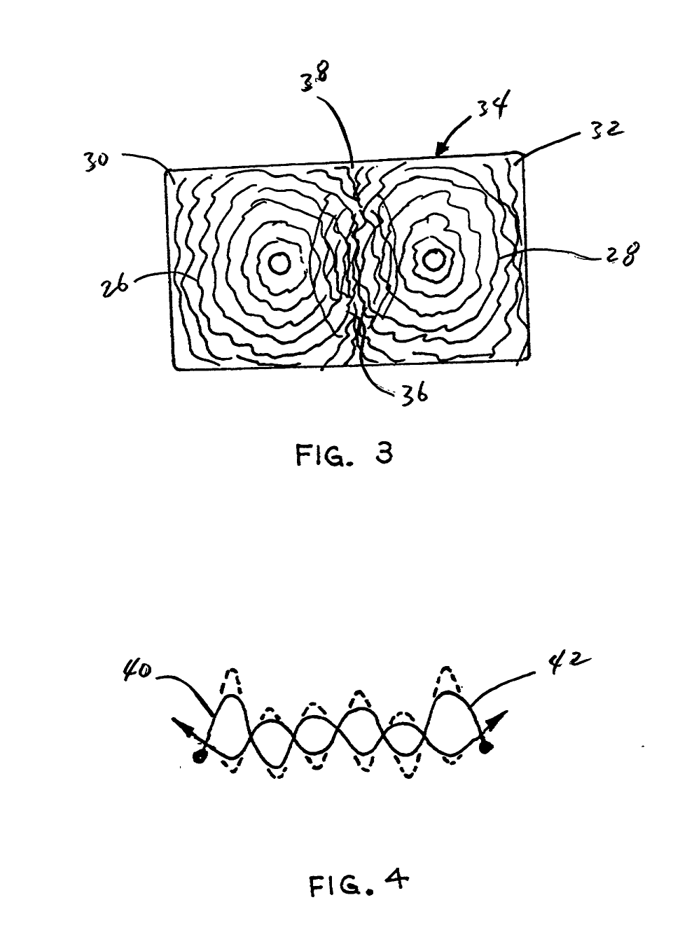

Referring to FIG. 2, there is illustratively shown a first wave form 18 generated by a first vibration generator 20 and a second wave form 22 generated by a second vibration generator 24 at two distinct areas prior to convergence.

Referring to FIG. 3, there is illustratively shown two bending wave vibrations 26 and 28 over two distinct areas 30 and 32 on a transmitting plate 34 in its initial vibration convergence. According to the present invention, when there is a distribution of resonant modes of the first bending wave vibration 26 over one area 30 of the transmitting plate 34, and there is another distribution of resonant modes of the second bending wave vibration 28 over another area 32 of the transmitting plate 34, then there will be a distribution of resonant modes of a third bending wave vibration 36 in area 38 located between areas 30 and 32, where the third bending wave vibration 36 is produced by the resonance or interaction of the first and second bending wave vibrations 26 and 28.

Referring to FIG. 4, there is illustratively shown two wave forms 40 and 42 in a destructive harmony, where the two wave forms create a lower amplitude of the harmony.

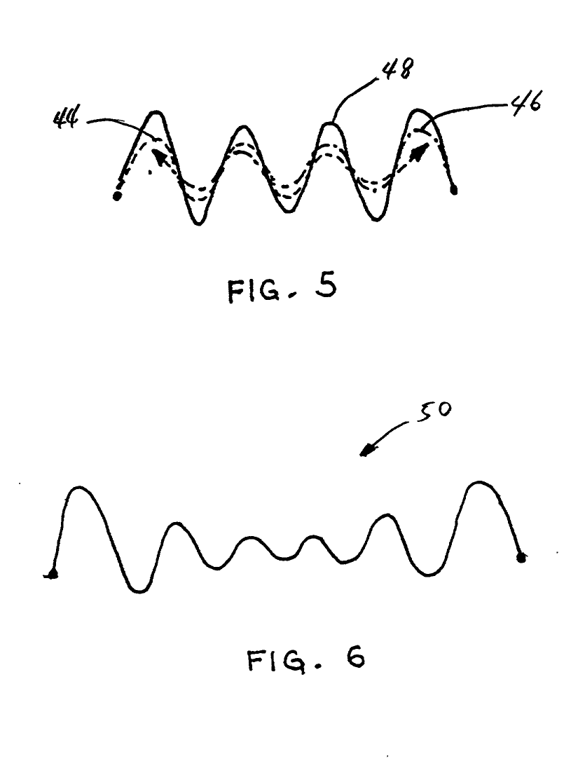

Referring to FIG. 5, there is illustratively shown two wave forms 44 and 46 (shown as dashed lines) in a constructive harmony (unison), where the two wave forms create a larger amplitude of the harmony 48.

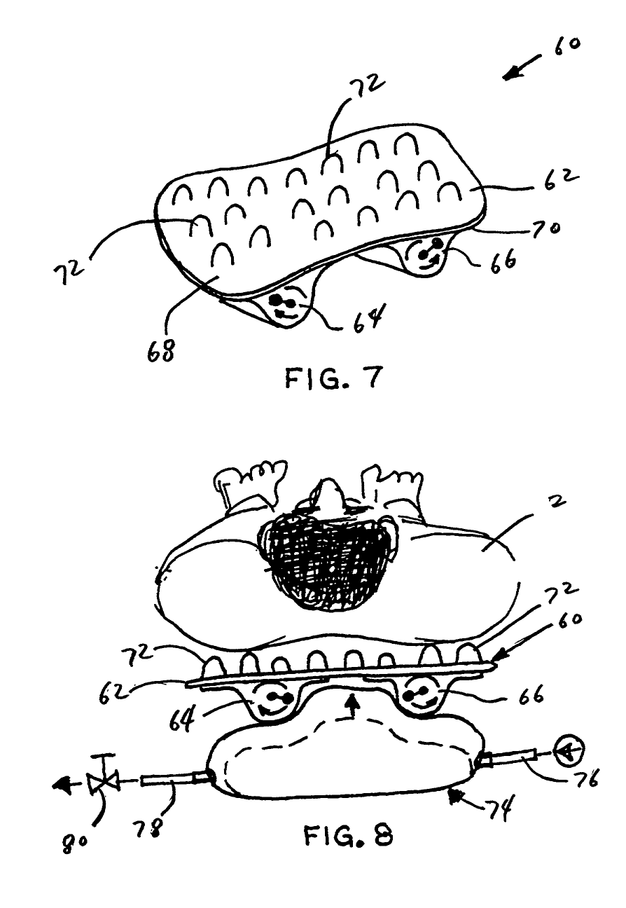

Referring to FIG. 6, there is illustratively shown the harmonic of two wave forms 50, wherein the wave forms are rising (constructive) and falling (destructive).

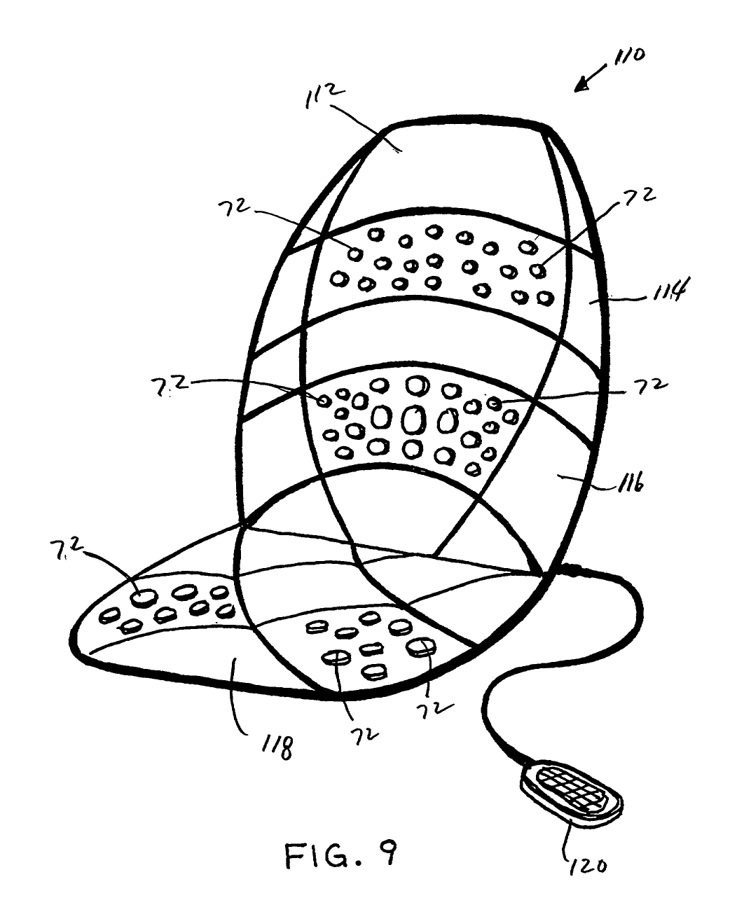

Referring to FIG. 7, there is illustratively shown at 60 a preferred embodiment of the present invention harmonic vibration massage device which includes a rectangular shaped harmonic transmitting plate or panel 62 and at least two vibration generators 64 and 66. The vibration generators may include eccentric motors, solenoids, transducers, sonic transducers, vibratory means or any other suitable means known to one skilled in the art. The harmonic transmitting plate 62 has a top side 68, a bottom side 70 and a plurality of spaced apart protruding fingertips or the like 72 integrally formed with the top side 68. The two vibration generators 64 and 66 are mounted by conventional means on the bottom side 70 of the harmonic transmitting plate 62 at two distinct areas. The protruding fingertips 72 permit more intimate and penetrate contact with harmonic plate vibrations. The harmonic transmitting plate 62 is generally made out of rubber material, soft PVC, or semi-firm material which interacts with the vibration generators 64 and 66 to produce harmonic vibrations for providing a harmonic massaging effect.

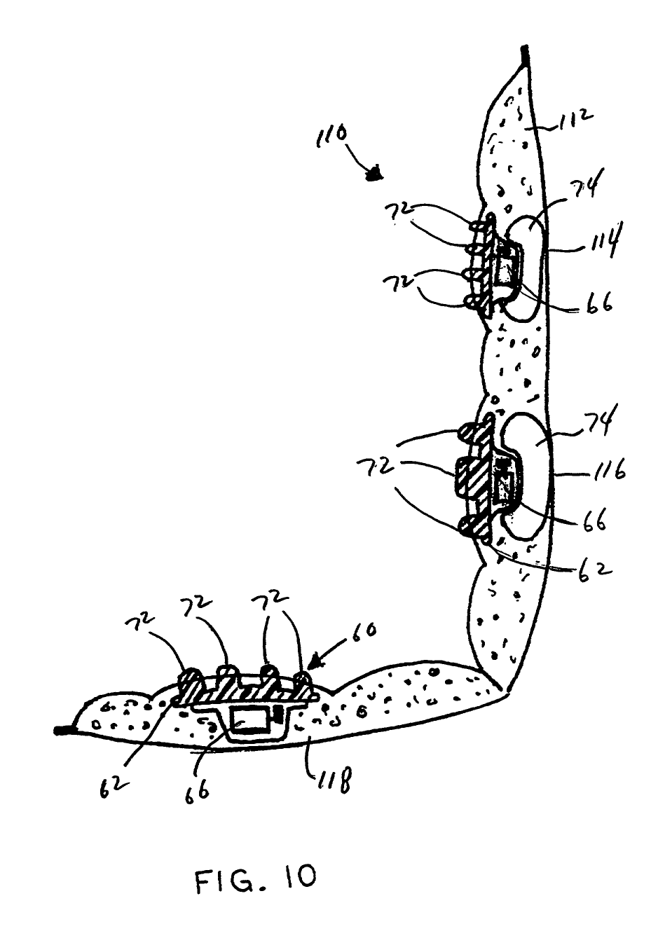

Referring to FIG. 8, there is shown the present invention harmonic vibration massage device 60 used in conjunction with a fluid filled bladder 74. The fluid filled bladder 74 is positioned underneath the transmitting plate 62 as shown. As the fluid filled bladder 74 is pressurized, it forces the massage device 60 upwardly against a body part of a user 2, thereby creating increased pressure against the body part of the user 2. The fluid filled bladder 74 provides both displacement with adjusting firmness against a user plus a damping media that accepts and adjusts harmonies.

The fluid filled bladder 74 has an inlet port 76 which is connected to air or fluid supply means (not shown) for pressurizing the bladder 74 and an outlet port 78 for depressurizing the bladder 74. The outlet port 78 may be connected to a valve 80 or control means for providing control over the outlet port 78.

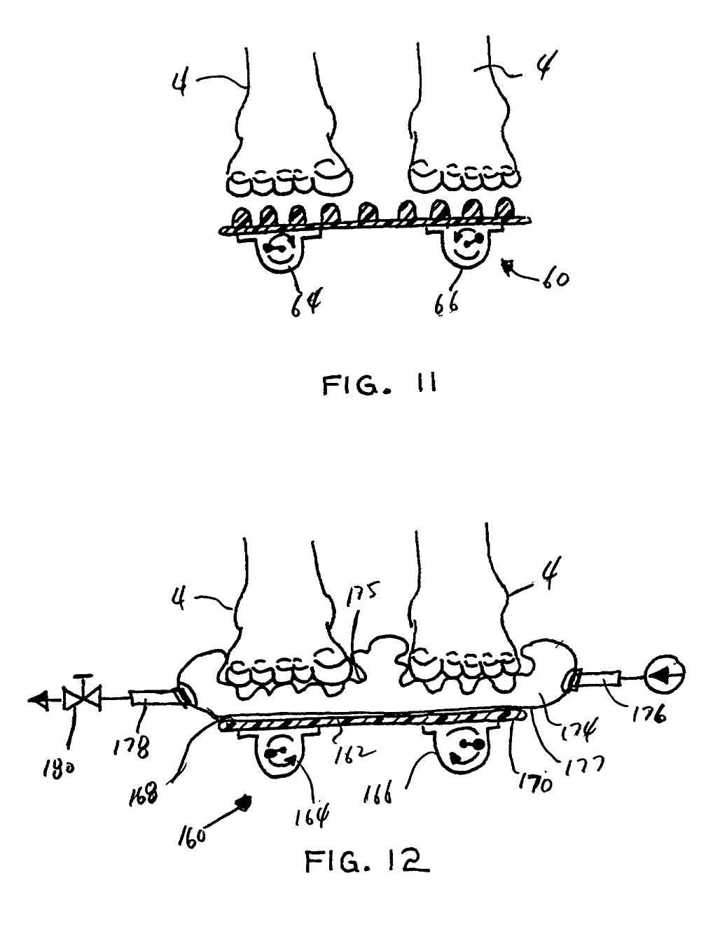

The above described embodiments of the present invention harmonic vibration massage device 60 can be implemented in many applications. Referring to FIGS. 9 and 10, there is shown one of the many applications of the present invention harmonic vibration massage device 60 incorporated into a cushioning apparatus 110. The cushioning apparatus 110 includes at least a head support section 112, a thoracic support section 114, a lumbar support section 116, and a buttock and thigh support section 118. Each support section may include the present invention harmonic vibration massage device 60 embedded thereto or therein. By way of example, only the thoracic support section 114, the lumbar support section 116 and the buttock and thigh support section 118 have the present invention harmonic vibration massage device 60 incorporated therein. The cushioning apparatus 110 further includes a control box 120 for controlling the harmonic massaging effect of the harmonic vibration massage devices 60 at different sections of the cushioning apparatus 110.

In the thoracic support section 114 of the cushioning apparatus 110, the present invention harmonic vibration massage device 60 is used in conjunction with the fluid filled bladder 74 as shown. In the lumbar support section 116 of the cushioning apparatus 110, the present invention harmonic vibration massage device 60 is used in conjunction with the fluid filled bladder 74 as shown. In the buttock and thigh support section 118, the present invention harmonic plate vibration massage device 60 is positioned thereto without the fluid filled bladder 74.

It will be appreciated that the cushioning apparatus 110 shown in FIG. 10 is not limited to the configuration shown. It is emphasized that while the configuration shown in FIG. 10 is preferred, it is also within the spirit and scope of the present invention to have any different configurations not shown. By way of example, all of the support sections of the cushioning apparatus may have the harmonic vibration massage device 60 embedded thereto with the fluid filled bladder 74. By way of example, all of the support sections of the cushioning apparatus may only have the harmonic vibration massage device embedded thereto.

The present invention harmonic vibration massage device 60 not only supports the weight of an individual who sits or rests on the device but provides a harmonic massaging effect on the body part of the individual positioned on the harmonic vibration massage device 60.

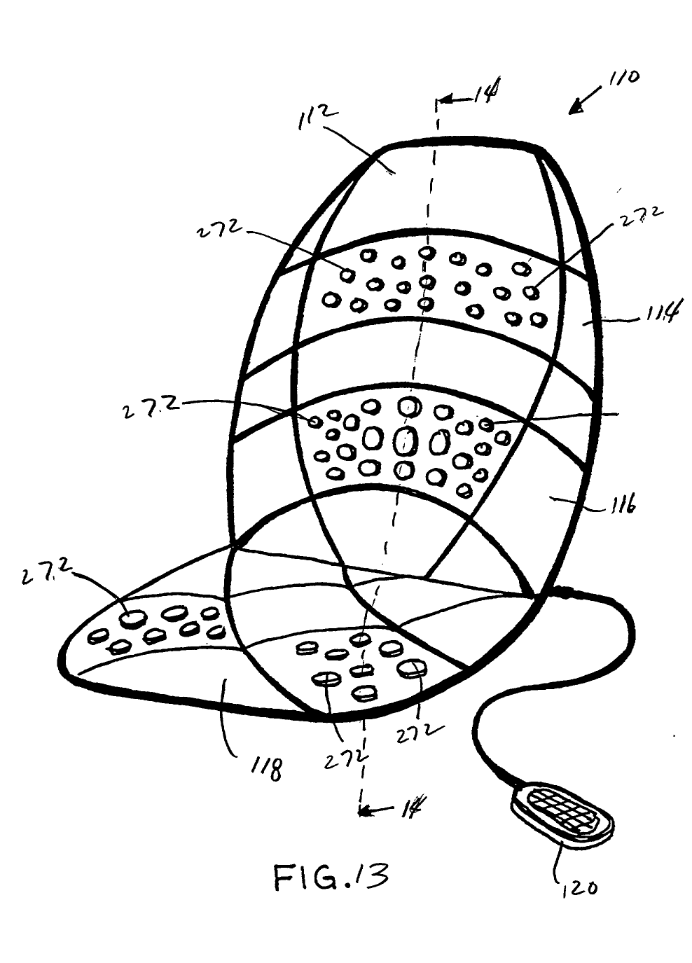

Referring to FIG. 11, there is illustratively shown the present invention harmonic vibration massage device 60 which can be used on the user's feet for providing a harmonic massaging effect on the user's feet.

Referring FIG. 12, there is shown another embodiment of the present invention harmonic vibration massage device 160 incorporated with a foot massage device. The vibration massage device 160 is used in conjunction with a fluid filled bladder 174. The harmonic vibration massage device 60 includes a rectangular shaped transmitting plate or panel 162 and at least two vibration generators 164 and 166. The vibration generators may include eccentric motors, solenoids, transducers, sonic transducers, vibratory means or any other suitable means known to one skilled in the art. The harmonic plate 162 has a generally flat top side 168 and a bottom side 170. The two vibration generators 164 and 166 are mounted by conventional means on the bottom side 170 of the harmonic plate 162 at two distinct areas. The harmonic plate 162 is generally made out of rubber material, soft PVC, or semi-firm material which interacts with the vibration generators 164 and 166 to provide a harmonic massaging effect.

The fluid filled bladder 174 has an irregular upper surface 175 positioned against the user's feet 4 and a lower surface 177 positioned against the transmitting plate 162. As the fluid filled bladder 174 is pressurized, it provides a better conformity to the user's feet 4, thereby creating increased pressure against the user's feet 4. The fluid filled bladder 174 provides both displacement with adjusting firmness against a user plus a damping media that accepts and adjusts harmonies.

The fluid filled bladder 174 further has an inlet port 176 which is connected to air or fluid supply means (not shown) for pressurizing the bladder 174 and an outlet port 178 for depressurizing the bladder 174. The outlet port 178 may be connected to a valve 180 or control means for providing control over the outlet port 178.

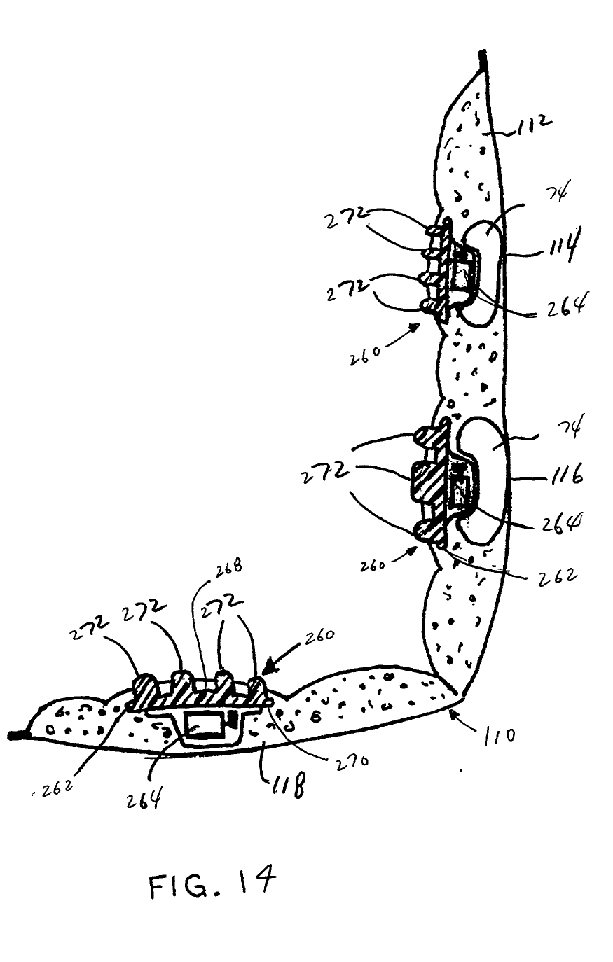

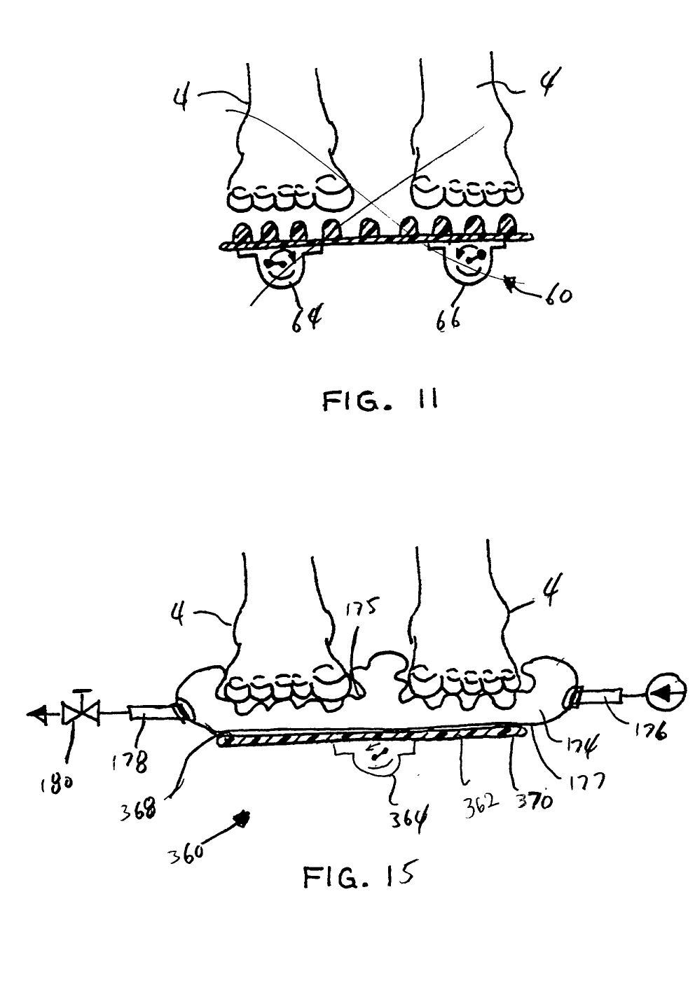

Referring to FIGS. 13 and 14, alternatively, there is shown at 260 the present invention vibration massage device which includes a rectangular shaped transmitting plate or panel 262 and at least one vibration generator 264. The vibration generator 264 may include an eccentric motor, solenoid, transducer, sonic transducer, vibratory means or any other suitable means known to one skilled in the art. The transmitting plate 262 has a top side 268, a bottom side 270 and a plurality of spaced apart protruding fingertips or the like 272 integrally formed with the top side 268. The protruding fingertips 272 may be semi-rigid or semi-flexible arch shaped tips. These arch shaped tips may be integrally formed with the transmitting plate 262 or manufactured by themselves and placed on top of the transmitting plate 262. The vibration generator 264 is mounted by conventional means on the bottom side 270 of the transmitting plate 262. The protruding fingertips 272 permit more intimate and penetrating contact with the plate vibration. The transmitting plate 262 is generally made out of rubber material, soft PVC, or semi-firm material which interacts with the vibration generator 264 to produce vibrations for providing an improved massaging effect.

The vibration massage device 260 can be used in conjunction with or without a fluid filled bladder 74 (see FIGS. 8 and 14) which is positioned underneath the transmitting plate 262 and covers the vibration generator 264. As the fluid filled bladder 74 is pressurized, it forces the transmitting plate 262 upwardly which in turn pushes the plurality of fingertips 272 upwardly against a body part of a user (not shown), thereby creating increased pressure against the body part of the user for providing an improved massaging effect. The fluid filled bladder 74 provides both displacement with adjusting firmness against a user plus a damping media.

The fluid filled bladder 74 is similar to the fluid filled bladder shown in FIG. 8, and the description thereof will not be repeated.

The above described embodiment of the present invention vibration massage device 260 can be implemented in many applications. One example is the cushioning apparatus 110. It will be appreciated that the cushioning support section 110 can either be a separate device which is placed on top of a lounge chair or alternatively, can be a device that is incorporated into and made part of a lounge chair. The cushioning apparatus 110 includes at least a head support section 112, a thoracic support section 114, a lumbar support section 116, and a buttock and thigh support section 118. Each support section may include the present invention vibration massage device 260 embedded thereto or therein. By way of example, only the thoracic support section 114, the lumbar support section 116 and the buttock and thigh support section 118 have the present invention vibration massage device 60 incorporated therein. The cushioning apparatus 110 further includes a control box 120 for controlling the massaging effect of the vibration massage devices 260 at different sections of the cushioning apparatus 110.

In the thoracic support section 114 of the cushioning apparatus 110, the present invention vibration massage device 260 is used in conjunction with the fluid filled bladder 74 as shown. In the lumbar support section 116 of the cushioning apparatus 110, the present invention vibration massage device 260 is used in conjunction with the fluid filled bladder 74 as shown. In the buttock and thigh support section 118, the present invention vibration massage device 260 is positioned thereto without the fluid filled bladder 74.

It will be appreciated that the cushioning apparatus 110 shown in FIGS. 13 and 14 is not limited to the configuration shown. It is emphasized that while the configuration shown in FIGS. 13 and 14 is preferred, it is also within the spirit and scope of the present invention to have any different configurations not shown. By way of example, all of the support sections of the cushioning apparatus may have the present invention vibration massage device 260 embedded thereto with the fluid filled bladder 74. By way of example, all of the support sections of the cushioning apparatus may only have the vibration massage device 260 embedded thereto.

The present invention vibration massage device 260 not only supports the weight of an individual who sits or rests on the device but provides an improved massaging effect on the body part of the individual positioned on the vibration massage device 260.

Referring to FIG. 15, there is illustratively shown the present invention vibration massage device 360 which can be used on the user's feet for providing an improved massaging effect on the user's feet. The vibration massage device 360 is used in conjunction with a fluid filled bladder 174. The vibration massage device 360 includes a rectangular shaped transmitting plate or panel 362 and at least one vibration generator 364. The vibration generator may include an eccentric motor, solenoid, transducer, sonic transducer, vibratory means or any other suitable means known to one skilled in the art. The transmitting plate 362 has a generally flat top side 368 and a bottom side 370. The vibration generator 364 is mounted by conventional means on the bottom side 370 of the transmitting plate 362. The plate 362 is generally made out of rubber material, soft PVC, or semi-firm material which interacts with the vibration generator 364 to provide an improved massaging effect.

The transmitting plate 362 may be manufactured with or without the plurality of protruding fingertips 272 as shown in FIG. 14.

The fluid filled bladder 174 has an irregular upper surface 175 positioned against the user's feet 4 and a lower surface 177 positioned against the transmitting plate 362. As the fluid filled bladder 174 is pressurized, it provides a better conformity to the user's feet 4, thereby creating increased pressure against the user's feet 4. The fluid filled bladder 174 provides both displacement with adjusting firmness against a user plus a damping media. The fluid filled bladder 174 further has an inlet port 176 which is connected to air or fluid supply means (not shown) for pressurizing the bladder 174 and an outlet port 178 for depressurizing the bladder 174. The outlet port 178 may be connected to a valve 180 or control means for providing control over the outlet port 178.

Defined in detail, the present invention is a vibration massage device, comprising: (a) a transmitting plate having an upper side, a bottom side and a plurality of spaced apart protruding fingertips integrally formed with the upper side of the transmitting plate; (b) at least one vibration generator mounted on the bottom side of the transmitting plate for generating vibrations to and through the transmitting plate which in turn is transmitted to and through the plurality of protruding fingertips for providing a massage effect to a body part positioned on the vibration massage device; (c) a fluid filled bladder having an upper surface and a lower surface, the upper surface positioned against the bottom side of the transmitting plate and against the at least one vibration generator; (d) means for supplying fluid under pressure to expand the fluid filled bladder to a desired stiffness which in turn forces the transmitting plate upwardly which in turn pushes the plurality of protruding fingertips upwardly against the body part, thereby creating increased pressure against the body part positioned on the plurality of protruding fingertips of the transmitting plate; and (e) means for cycling the inflation and deflation rates at different intervals of the fluid filled bladder to create a massaging pattern to massage the body part positioned on the massage device.

Defined broadly, the present invention is a vibration massage device, comprising: (a) transmitting means having a plurality of protruding fingertips; (b) means for generating vibrations to and through the transmitting means for providing a massage effect to a body part positioned on the massage device; (c) a fluid filled bladder positioned against the transmitting means and against the vibration generating means; and (d) means for supplying fluid under pressure to expand the fluid filled bladder to a desired stiffness which in turn forces the plurality of protruding fingertips against the body part, thereby creating increased pressure against the body part positioned against the plurality of protruding fingertips of the transmitting means.

Defined more broadly, the present invention is a vibration massage device, comprising: (a) a transmitting plate having an upper side and a bottom side; (b) a plurality of spaced apart protruding fingertips positioned on the upper side of the transmitting plate; and (c) at least one vibration generator mounted on the bottom side of the transmitting plate for generating vibrations to and through the transmitting plate which in turn is transmitted to and through the plurality of protruding fingertips for providing a massage effect to a body part positioned on the vibration massage device.

Defined even more broadly, the present invention is a massage device, comprising: (a) transmitting means; and (b) means for generating vibrations to and through the transmitting means for providing a massage effect to a body part positioned against the massage device.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The present invention has been described in considerable detail in order to comply with the patent laws by providing full public disclosure of at least one of its forms. However, such detailed description is not intended in any way to limit the broad features or principles of the present invention, or the scope of the patent to be granted. Therefore, the invention is to be limited only by the scope of the appended claims.

What is claimed is:

1. A vibration massage device, comprising:
a. a transmitting plate having an upper side, a bottom side and a plurality of spaced apart protruding fingertips integrally formed with the upper side of the transmitting plate;
b. at least one vibration generator mounted on said bottom side of said transmitting plate for generating vibrations to and through said transmitting plate which in turn is transmitted to and through said plurality of protruding fingertips for providing a massage effect to a body part positioned on said vibration massage device;
c. a fluid filled bladder having an upper surface and a lower surface, the upper surface positioned against said bottom side of said transmitting plate and against said at least one vibration generator;
d. means for supplying fluid under pressure to expand said fluid filled bladder to a desired stiffness which in turn forces said transmitting plate upwardly which in turn pushes said plurality of protruding fingertips upwardly against the body part, thereby creating increased pressure against the body part positioned on said plurality of protruding fingertips of said transmitting plate; and
e. means for cycling the inflation and deflation rates at different intervals of said fluid filled bladder to create a massaging pattern to massage the body part positioned on said massage device.

2. The vibration massage device in accordance with claim 1, wherein said vibration massage device is incorporated into a cushioning apparatus.

3. The vibration massage device in accordance with claim 1, wherein said vibration massage device is incorporated into a foot massage apparatus.

4. The vibration massage device in accordance with claim 1, wherein said transmitting plate and said plurality of protruding fingertips are made out of rubber material.

5. A vibration massage device, comprising:
a. transmitting means having a plurality of protruding fingertips;
b. means for generating vibrations to and through said transmitting means for providing a massage effect to a body part positioned on said massage device;
c. a fluid filled bladder positioned against said transmitting means and against said vibration generating means; and
d. means for supplying fluid under pressure to expand said fluid filled bladder to a desired stiffness which in turn forces said plurality of protruding fingertips against the body part, thereby creating increased pressure against the body part positioned against said plurality of protruding fingertips of said transmitting means.

6. The vibration massage device in accordance with claim 5, further comprising means for cycling the inflation and deflation rates at different intervals of said fluid filled bladder to create a massaging pattern to massage the body part positioned on said massage device.

7. The vibration massage device in accordance with claim 5, wherein said transmitting means includes a plate.

8. The vibration massage device in accordance with claim 7, wherein said plate and said plurality of protruding fingertips are made out of rubber material.

9. The vibration massage device in accordance with claim 5, wherein said vibration massage device is incorporated into a cushioning apparatus.

10. The vibration massage device in accordance with claim 5, wherein said vibration massage device is incorporated into a foot massage apparatus.

11. A vibration massage device, comprising:
a. a transmitting plate having an upper side and a bottom side;
b. a plurality of spaced apart protruding fingertips positioned on said upper side of said transmitting plate; and
c. at least one vibration generator mounted on said bottom side of said transmitting plate for generating vibrations to and through said transmitting plate which in turn is transmitted to and through said plurality of protruding fingertips for providing a massage effect to a body part positioned on said vibration massage device.

12. The vibration massage device in accordance with claim 11, further comprising a fluid filled bladder positioned against said transmitting plate and against said at least one vibration generator, where means for supplying fluid under pressure to expand the fluid filled bladder to a desired stiffness which in turn forces said plurality of protruding fingertips against the body part, thereby creating increased pressure against the body part positioned against said plurality of protruding fingertips.

13. The vibration massage device in accordance with claim 12 further comprising means for cycling the inflation and deflation rates at different intervals of said fluid filled bladder to create a massaging pattern to massage the body part positioned on said massage device.

14. The vibration massage device in accordance with claim 11, wherein said vibration massage device is incorporated into a cushioning apparatus.

15. The vibration massage device in accordance with claim 11, wherein said vibration massage device is incorporated into a foot massage apparatus.

16. The vibration massage device in accordance with claim 11, wherein said transmitting plate and said plurality of protruding fingertips are made out of rubber material.

17. A massage device, comprising:
a. transmitting means; and
b. means for generating vibrations to and through said transmitting means for providing a massage effect to a body part positioned against said massage device.

18. The massage device in accordance with claim 17, further comprising a plurality of protruding fingertips positioned against said generating means.

19. The massage device in accordance with claim 18, further comprising a fluid filled bladder positioned on top or underneath said transmitting plate, and having means for supplying fluid under pressure to expand the fluid filled bladder to a desired stiffness which in turn forces said plurality of protruding fingertips against the body part, thereby creating increased pressure against the body part positioned against said plurality of protruding fingertips.

20. The massage device in accordance with claim 19, further comprising means for cycling the inflation and deflation rates at different intervals of said fluid filled bladder to create a massaging pattern to massage the body part positioned on said massage device.

21. The massage device in accordance with claim 19, wherein said fluid filled bladder has an irregular surface for conforming to the body part.

22. The massage device in accordance with claim 17, wherein said transmitting means includes a plate.

23. The massage device in accordance with claim 22, wherein said plate is made out of rubber material.

24. The massage device in accordance with claim 17, wherein said generating means include vibration generators.

25. The massage device in accordance with claim 17, wherein said generating means include eccentric motors.

26. The massage device in accordance with claim 17, wherein said massage device is incorporated into a cushioning apparatus.

27. The massage device in accordance with claim 17, wherein said massage device is incorporated into a foot massage apparatus.
